(19) United States
(12) Patent Application Publication
(10) Pub. No.: US 2009/0237044 A1
(43) Pub. Date: Sep. 24, 2009

(54) Bidirectional interleaved DC to DC converter utilizing positively coupled filter inductors

(76) Inventors: Orges Gjini, Clifton Park, NY (US); Michael Joseph Krok, Clifton Park, NY (US); Herman Lucas Norbert Wiegman, Niskayuna, NY (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/077,266

(22) Filed: Mar. 18, 2008

(51) Int. Cl. G05F 1/10

(52) U.S. Cl. 323/239

(57) ABSTRACT

A bidirectional interleaved DC to DC converter comprises positively coupled filter inductors that are coupled to a switching network that receives power from a DC power source, such as a battery. The positively coupled inductors are integrated as a single coupled inductor, which allows the DC to DC converter to convert DC voltage to various voltage levels with reduced voltage ripple, without the need for supplemental filter capacitors that are large and costly.

### TECHNICAL FIELD

Generally, the present invention relates to DC to DC converters. Particularly, the present invention relates to a DC to DC converter that utilizes mutually coupled filter inductors. More particularly, the present invention relates to a DC to DC converter that utilizes mutually coupled filter inductors with a positive coupling coefficient, allowing a filter capacitor maintained by the converter to be reduced in size, such that the converter converts DC voltage (current) from one level to another with reduced voltage ripple.

### BACKGROUND ART

Bidirectional DC to DC converters are typically used to convert DC voltage (current) from a given level to another, such that the converted DC voltage has a time-varying AC component or ripple that is compatible with the requirements or specifications of various electrical components that require DC power. That is, DC to DC converters are able to efficiently convert DC voltage (current) from one level, such as a high-voltage level, to another DC voltage level, such as a low-voltage level without the addition of a significantly large AC component or ripple. In addition to being able to convert DC power to various voltage levels, a DC to DC converter that is capable of bidirectional operation is able to convert DC power to different voltage (current) levels depending on the direction of the flow of electrical current through the converter. Thus, because of these features, bidirectional DC to DC converters are utilized in various applications where different DC voltage (current) power levels are needed.

Bidirectional DC to DC converters have been utilized by airships, or other lighter-than-air platforms, which utilize DC power from batteries to power various propulsion systems maintained by the platform. One type of bidirectional DC to DC converter used with an airship utilizes single interleaved converters with filter inductors that are not mutually coupled. However, because the charging and discharging cycles of the batteries used for powering the various propulsion systems of the airship differ in time for duty cycles other than 50%, the waveform of the current ripple passing through the converter is asymmetrical. Unfortunately, the non-coupled DC to DC converter is unable to cancel the asymmetrical ripple currents of the asymmetrical current waveform, which results in an output voltage from the converter that has significant ripple, which is not desirable for the optimal operation of DC powered electrical components, such as those aboard the airship.

To reduce the amount of ripple, or sometimes referred to as an AC component imposed on the DC power, various attempts have been made to incorporate supplemental filter capacitors into the design of the DC to DC converter. While the use of the additional filter capacitors in conjunction with the DC to DC converter provides an output voltage with reduced ripple, the added capacitors substantially increase the size of the DC to DC converter. This increased size is undesirable in an airship, as it has limited payload area, inasmuch as the airship relies upon its buoyancy to navigate efficiently. Moreover, the addition of supplemental filter capacitors also adds significantly to the cost of manufacturing the DC to DC converter.

Therefore, there is a need in the art for a bidirectional DC to DC converter that converts electrical voltage from one level to another level with reduced voltage ripple or AC component, without utilizing large, bulky supplemental filtering capacitors. In addition, there is a need for a bidirectional DC to DC converter that utilizes mutually-coupled filter inductors with a positive coupling coefficient. Furthermore, there is a need for a bidirectional DC to DC converter that utilizes an output capacitor with reduced size and weight, while maintaining a reduced voltage ripple.

### SUMMARY OF INVENTION

In light of the foregoing, it is a first aspect of the present invention to provide a bidirectional DC to DC converter utilizing positively coupled filter inductors.

Another aspect of the present invention is to provide a bidirectional interleaved DC to DC converter for converting DC power from one voltage level to another voltage level comprising a switching network having a first input/output node, a pair of positively coupled inductors coupled to the switching network to form a second input/output node, and a controller coupled to the switching network, the controller actuating the switching network, such that power supplied to the first input/output node at one voltage level is converted into another voltage level at the second input/output node, and vice versa, the positively coupled inductors reducing the voltage ripple associated with converted voltage.

### BRIEF DESCRIPTION OF THE DRAWINGS

These and other features and advantages of the present invention will become better understood with regard to the following description, appended claims, and accompanying drawings wherein:

FIG. 1 is a schematic diagram of an energy generation system utilizing an interleaved bidirectional DC to DC converter in accordance with the concepts of the present invention;

FIGS. 2A and 2B are schematic views of the bidirectional DC to DC converter in accordance with the concepts of the present invention;

FIG. 3 is a graph showing the electrical currents that are processed by the interleaved positively coupled inductors of the converter to reduce the voltage ripple output by the converter in accordance with the concepts of the present invention;

FIG. 4 is a graph showing an output voltage of the converter using interleaved positively coupled inductors of the present invention having approximately the same amount of output voltage ripple as compared to a converter that uses interleaved non-coupled inductors and an output filtering capacitor that has twice the capacitance as that provided by the converter using interleaved positively coupled inductors; and

FIG. 5 is a graph showing an output voltage of the converter using interleaved positively coupled inductors of the present invention having approximately half of the output voltage ripple as compared to a converter that uses interleaved non-coupled inductors and an output filtering capacitor that has the same amount of capacitance as that provided by the converter using interleaved positively coupled inductors.

### BEST MODE FOR CARRYING OUT THE INVENTION

Before setting forth the structural and functional details associated with the present invention, a brief discussion of the particular context in which the present invention may be utilized will be provided below, as it is believed it will assist the reader in understanding the invention.

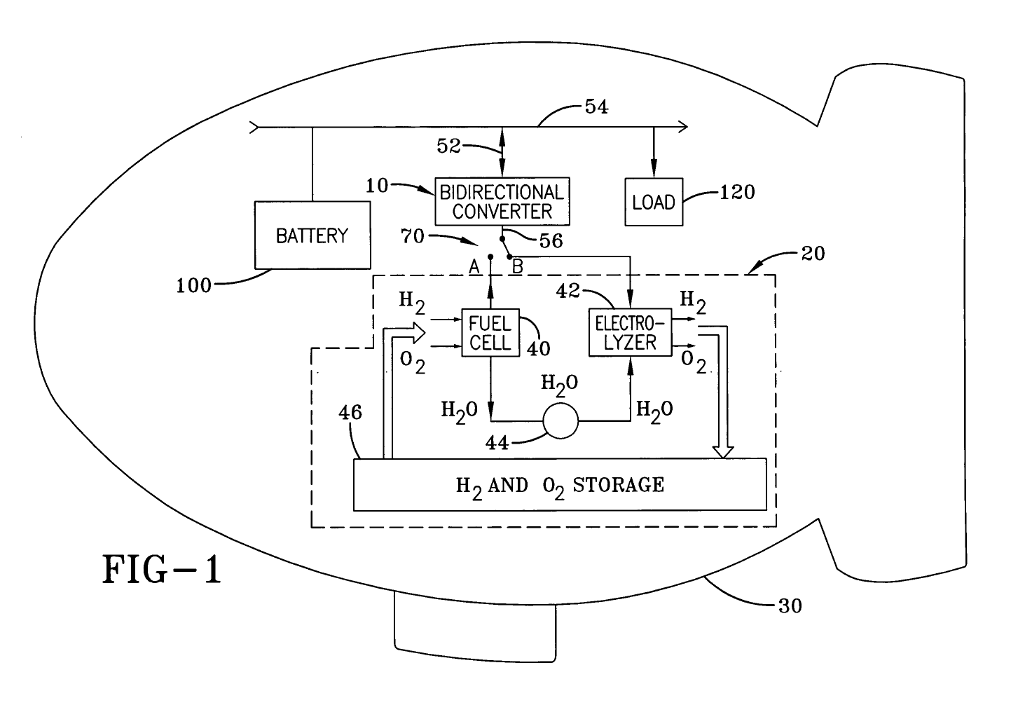

A bidirectional DC to DC converter, generally referred to by the numeral 10, used in association with an energy generation system 20 maintained aboard an airship, or other lighter than air platform 30, is shown in FIG. 1. Of course, the converter 10 could be used in any application. In particular, the energy generation system 20 is comprised of a fuel cell 40 and an electrolyzer 42 that are coupled together by an H₂O storage tank 44 and an H₂/O₂ storage tank 46. The bidirectional DC to DC converter 10 is configured such that an input/output node 52 maintained by the converter 10 is coupled to a DC bus 54, while another input/output node 56 maintained by the converter 10 is coupled to a switch 70. The switch 70 maintains two positions designated A and B, and as such, when the switch 70 is in position A, the converter 10 is coupled to the fuel cell 40, and when the switch 70 is in position B, as shown, the converter 10 is coupled to the electrolyzer 42.

A battery 100, as well as any other power source or electrical load 120 to be driven, may be coupled to the DC bus 54. For example, the load 120 may be an electric powered propulsion unit that propels the airship 30 may be coupled to the DC bus 54. As such, DC power may be bidirectionally transferred to and from the DC to DC converter 10 depending on whether power is being supplied via the DC bus 54 to the energy generation system 20, or whether power is being supplied from the energy generation system 20 to the DC bus 54.

For example, when the energy generation system 20 is actively generating power, the switch 70 is placed in position A, and the operation of the fuel cell 40 is initiated. Next, H₂ (hydrogen gas) and O₂ (oxygen gas) are supplied to the fuel cell 40 from the H₂/O₂ storage tank 46. The fuel cell 40 then acts on the H₂ and O₂ gases to generate low-voltage, high-current electrical power and H₂O (water). The generated H₂O is stored in the H₂O storage tank 44, while the electrical power generated is supplied to the bidirectional DC to DC converter 10. The converter 10 converts the low-voltage, high-current power into high-voltage, low-current power for delivery to the DC bus 54. Once the converted power is supplied to the DC bus 54 it may be supplied to the battery 100 for charging or the converted power may be delivered to the electrical load 120 also coupled to the bus 54.

Alternatively, when the power generation system 20 is not generating power, the switch 70 is placed into position B, such that the battery 100 is coupled to the electrolyzer 42 via the DC to DC converter 10. During this mode of operation, the DC to DC converter 10 converts the high-voltage, low-current power delivered from the battery 100 into low-voltage, high-current power that is supplied to the electrolyzer 42. Utilizing the power from the battery 100, the electrolyzer 42 disassociates H₂ (hydrogen gas) and O₂ (oxygen gas) from the water supplied from the H₂O storage tank 44. The H₂ (hydrogen gas) and O₂ (oxygen) generated therefrom are then stored at the H₂/O₂ storage tank 46 for subsequent use by the fuel cell 40. As such, it is evident that the use of the bidirectional DC to DC converter 10 enables the airship 30 to efficiently make use of the energy generating aspects of the fuel cell 40 and the electrolyzer 42. With the context of the operation of the bidirectional DC to DC converter 10 set forth, a detailed discussion of the particular aspects of the bidirectional DC to DC converter 10 in accordance with the concepts of the present invention will now be presented.

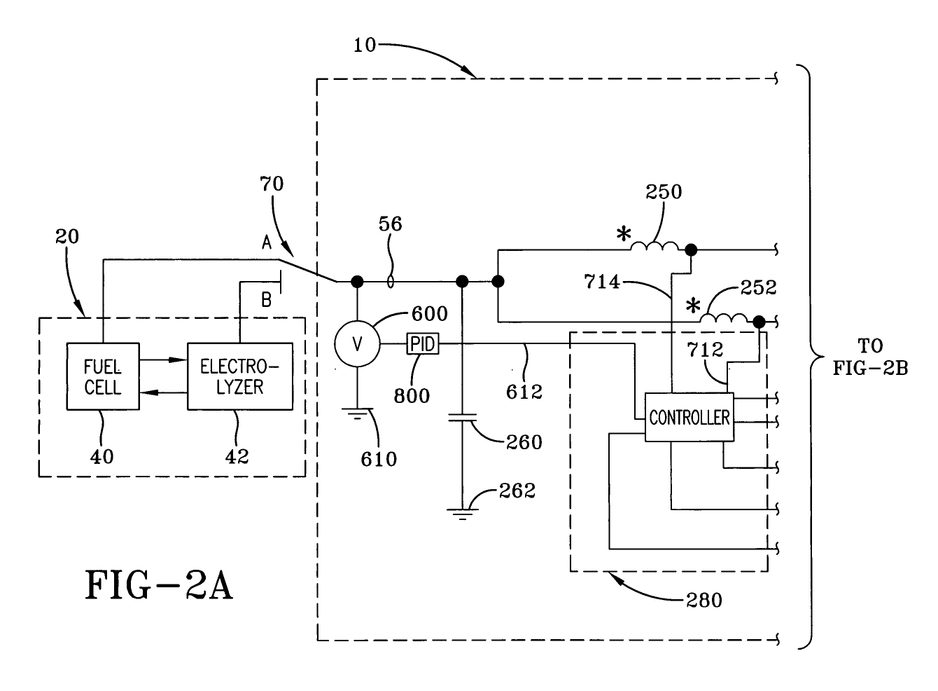

Continuing to FIGS. 2A-B, the bidirectional DC to DC converter 10 according to the concepts of the present invention, includes bidirectional input/output nodes 52 and 56 that are configured, such that when one node 52 or 56 is receiving power, the other node 56 or 52 is supplying power, and vice versa. Specifically, the converter 10 includes a switching network 230 that comprises a plurality of insulated gate bipolar transistors (IGBT) 240A-D that are coupled together in an interleaved bridge-type configuration. Coupled between the input/output node 56 and the switching network 230 is a pair of inductors 250 and 252, whereby the inductors 250 and 252 are integrated as a single, coupled inductor with a positive mutual coupling coefficient.

Coupled at the input/output node 56 at one end is a filtering capacitor 260, while the other end is coupled to a ground terminal 262. Additionally, a filtering capacitor 270 is coupled between the switching network 230 and the input/output node 52. In order to control the operation of the switching network 230, a controller 280 is provided by the converter 10. The controller 280 analyzes the voltages and electrical current levels at several nodes of the converter 10, and supplies suitable control signals to each of the IGBT's 240A-D to turn them on and off, or otherwise actuate them, as needed to achieve a desired level of DC power conversion between the input/output nodes 52 and 56, while maintaining a reduced amount of voltage ripple. Moreover, the positive coupling coefficient of the positively coupled inductors 250,252 allows the DC to DC converter 10 to output power with reduced voltage ripple at its nodes 52 and 56, without the need for large, costly filtering capacitors.

Specifically, the switching network 230 of the DC to DC converter 10 comprises insulated gate bipolar transistors (IGBT) 240A-D that are coupled together in a bridge configuration. While the use of IGBTs 240A-D are contemplated, such should not be construed as limiting, as any other suitable switching devices, such as a BJTs (Bipolar Junction Transistor), or MOSFETs (metal oxide semiconductor field effect transistor), may be used to comprise the switching network 230. The transistors 240A and 240C are coupled by their collector terminals (C) to the input/output node 52, while their gate terminals (G) are coupled to the controller 280. Coupled between the collector terminals (C) and the emitter terminals (E) of the transistors 240A,240C are respective diodes 400 and 410, such that the cathodes of the diodes 400,410 are coupled to node 52 and the anodes of the diodes 400,410 are coupled to the respective emitter terminals (E) of the transistors 240A,240C. The transistors 240B and 240D are arranged such that their collector terminals (C) are respectively coupled to the emitter terminals (E) of the transistors 240A and 240B, so as to form respective nodes 420 and 430. Coupled between the collector terminals (C) and the emitter terminals (E) of the transistors 240B,240D are respective diodes 440 and 450. The diodes 440,450 are arranged, such that the cathode of the diodes 440,450 are coupled to the collector terminal (C) of the respective transistors 240B,240D, while the anode of the diodes 440,450 are coupled to the emitter terminal (E), which are also coupled to ground terminals 452 and 454, of the respective transistors 240C,240D. Finally, the gate terminals (G) of the transistors 240B,240D are coupled to the controller 280.

The inductors 250 and 252 are coupled to the switching network 230, such that inductor 250 is coupled between node 430 and the input/output node 56, whereas the inductor 252 is coupled between node 420 and the input/output node 56.

To monitor the voltage at the input/output node 56, a voltage sensor 600 is coupled between the input/output node 56 of the converter 10 and a ground terminal 610. The voltage sensor 600 may also coupled to the controller 280 via monitor line 612 to allow the controller 280 to monitor the voltage level at the input/output node 56. In particular, the voltage sensor 600 serves as the primary sensor for providing control feedback to the switching network 230 maintained by the DC to DC converter 10. It should be appreciated that the voltage control is a critical function, as the various charging circuits and propulsion loads coupled to the bus 54 are strongly affected by voltage variations.

The controller 280 provided by the converter 10 may comprise any suitable general purpose or application specific computing device configured with the hardware and software needed to carry out the functions to be set forth. As discussed above, the controller 280 is coupled to the gate terminals (G) of the transistors 240A-D via respective interface circuits, such as gate drivers, through control lines 700, 702, 704, and 706 and is configured to supply suitable control signals thereto to actuate the IGBTs 240A-D between their on and off states so as to effectuate the DC power conversion functions provided by the converter 10. In addition, the controller 280 is coupled to nodes 52, 420, and 430 via respective monitor lines 710, 712, and 714, thereby enabling the controller 280 to monitor the voltage levels present at the associated nodes. It should also be appreciated, the monitoring of the voltage levels of the nodes allows the converter 10 to maintain the voltage of the bus 54 in a narrow range to facilitate the efficient operation of the propulsion units or other electrical load that may be coupled thereto.

Thus, due to the arrangement of the IGBTs 240A-D maintained by the switching network 230, and the inductors 250,252, the input/output node 52 is configured as the high-voltage node, while the input/output node 56 is configured as the low-voltage node. In other words, the input/output node 56 is configured to receive low-voltage, high-current power, which the switching network 230 converts into high-voltage, low-current power for supply to the input/output node 52. Alternatively, the input/output node 52 is configured to receive high-voltage, low-current power, which the switching network 230 converts into low-voltage, high-current power for supply to the input/output node 56.

With the structural relationships between the components of the bidirectional DC to DC converter 10 set forth above, the discussion that follows will be directed to the utilization of the converter 10 in association with the energy generation system 20 maintained by the airship 30. However, it should be understood that the use of the converter 10 is not limited to its use with an airship 30, as it is contemplated that the bidirectional DC to DC converter 10 may be utilized to convert power in any desired context or application.

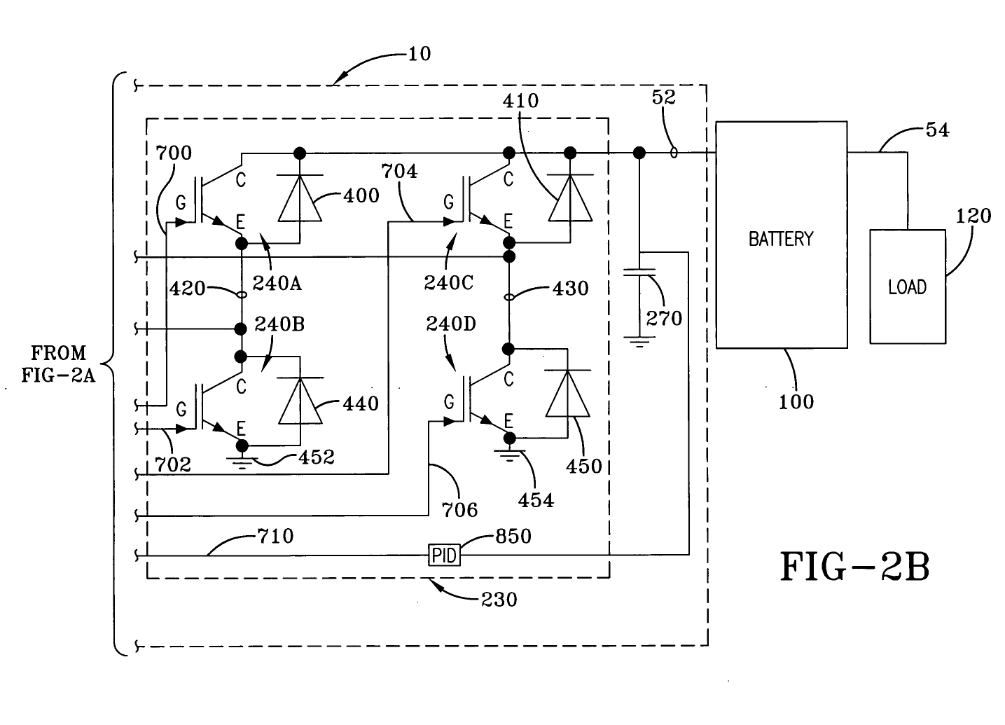

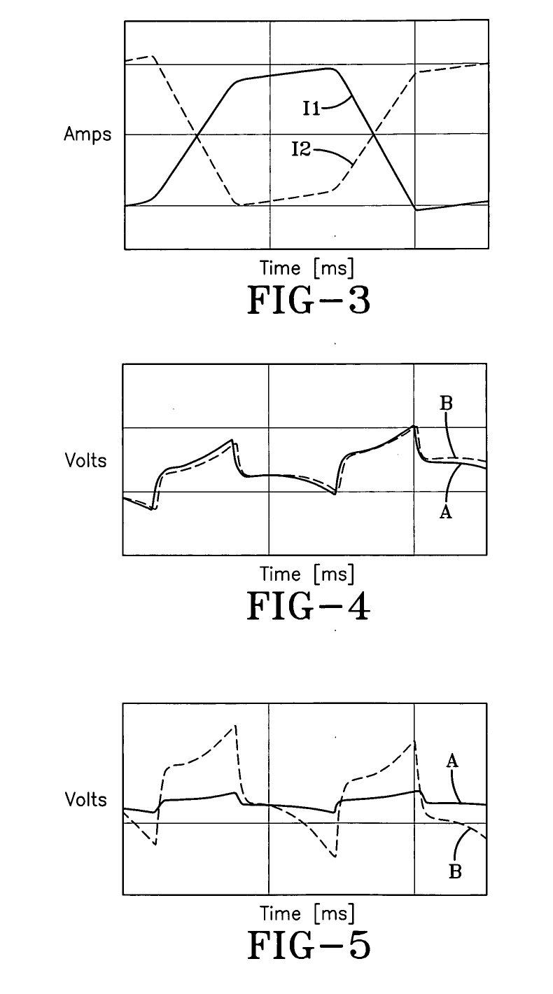

During the forward operation (from the input/output node 52 to the input/output node 56) of the converter 10, when input power from the battery 100 is received at the input/output node 52, the IGBTs 240A and 240C are controlled on and off, and the IGBTs 240B and 240D are turned off, and remain off. Specifically, the IGBTs 240B and 240D are turned on and off in accordance with control signals sent from the controller 280 to the gate terminal (G) via respective control lines 700 and 704, such that the pulses of the respective control signals are 180 degrees out of phase with one another. The high-voltage, low-current power supplied from the battery 100 is switched by the IGBTs 240A and 240C and diodes 440 and 450 via the controller 280. When the IGBTs 240A and 240C are turned on, current flows through the positively coupled inductors 250 and 252. And when the switches 240A and 240C are turned off, the voltage maintained by the inductors 250,252 oppose the voltage of the battery 100, to thereby reduce the voltage supplied by the battery 100. Thus, to effectuate the desired level of power conversion, the IGBTS 240A and 240C are turned on and off in accordance with a duty cycle calculated by the controller 280. The particular duty cycle controls the voltage that is subtracted from the voltage supplied by the battery 100 to generate low-voltage, high-current power with some amount of voltage ripple. After processing by the switching network 230, the low-voltage, high-current power is processed by the inductors 250 and 252, whereby due to their positive coupling, they are able to cancel the phase currents that form the voltage ripple. For example, FIG. 3 shows the opposing phase currents, designated as I1 and I2, as they move through the positively coupled inductors 250 and 252, such that the sum of I1 and I2 produces an output voltage at node 56 that has a reduced amount of ripple, as shown by identifier A in FIG. 4. That is, the filtering capacitor 260 also serves to reduce the amount of voltage ripple that is found on the voltage output by the DC to DC converter 10, before being delivered to the electrolyzer 42.

Returning to FIGS. 2A and 2B, the voltage (current) supplied to the electrolyzer 42 at node 56 is sensed directly by the voltage sensor 600, and processed through a PID (proportional-integral-derivative) controller 800, which is subsequently fed back to the controller 280 via monitor line 612. The controller 280 utilizes the processed voltage values to ascertain or otherwise calculate the duty cycle (on/off states) of the phase shifted control signals to be supplied to the IGBTs 240A and 240C, as previously discussed. In addition, the current supplied to the electrolyzer 42 via the converter 10 is also monitored by the controller 280 via monitor lines 712 and 714. As such, the controller 280 ensures that the current delivered to the electrolyzer 42 via node 56 does not exceed an allowed threshold.

During reverse operation (from the input/output node 56 to the input/output node 52) of the converter 10, low-voltage, high-current power is provided by the fuel cell 40 to the input/output node 56 of the converter 10. Initially, the filtering capacitor 260 removes an initial amount of ripple associated with the power supplied by the fuel cell 40. Next, IGBTs 240B and 240D are actively controlled on and off by the controller 280, and IGBTs 240A and 240C remain off. Specifically, the IGBTs 240B and 240D are turned on and off in accordance with control signals sent from the controller 280 to the gate terminal (G) via respective control lines 702 and 706, such that the pulses of the respective control signals are 180 degrees out of phase with one another. When IGBTs 240B and 240D are turned off, the voltage maintained by the coupled inductors 250,252 is added to the voltage provided by the fuel cell 40. The switching of the IGBTs 240B and 240D on and off along with the operation of the diodes 400,410 controls the voltage that is added from the inductors 250,252 to the voltage from the fuel cell 40. And as such, the coupled inductors 250,252 serve to convert the low-voltage, high-current power into a high-voltage, low-current power source, which is delivered by the IGBT's 240B and 240D to the filtering capacitor 270. Furthermore the inductors 250 and 252 due to their positive coupling, cancel the phase currents that may form the voltage ripple at the input/output node 52. The filtering capacitor 270 serves to filter the converted high-voltage, low-current power to reduce the amount of voltage ripple that may be present, before delivering the power to the battery 100 via the input/output node 52 for charging.

The voltage (current) supplied to the battery 100 at node 52 is sensed and processed by a PID (proportional-integral-derivative) controller 850, which is subsequently fed back to the controller 280 via monitor line 710. The controller 280 utilizes the processed voltage values to ascertain or otherwise calculate the duty cycle (on/off states) of the phase shifted control signals to be supplied to each of the IGBTs 240B and 240D, as previously discussed. In addition, the current supplied to the battery 100 is also monitored by the controller 280 via monitor lines 712 and 714. As such, the controller 280 ensures that the current delivered to the battery 100 via node 52 does not exceed an allowed threshold.

It should be appreciated that the amount of phase shift between the control signals is determined by the formula 360/N, where “N” is equal to the number of interleaved circuit branches established by the switching network 230. For example, the converter 10 shown in FIGS. 2A and 2B has a value of “N” that is equal to 2, which is equal to the number of interleaved circuit branches defined by IGBTs 240A/240C and IGBTs 240B/240D, however such should not be construed as limiting as the as the switching network 230 may be readily modified to accommodate additional interleaved circuit branches.

Thus, the converter 10 is configured to produce a voltage output at output node 56 that has reduced ripple, but does not require a filtering capacitor 260 that is large, heavy, and bulky. For example, as shown in FIG. 4, the converter 10, indicated by identifier A, is able to output a voltage with approximately the same amount of voltage ripple as a converter, indicated by the identifier B, that is structurally equivalent to the converter 10, but utilizes a filtering capacitor that has twice the capacitance of the filtering capacitor 260, and uses interleaved non-coupled inductors in place of the interleaved coupled inductors 250 and 252. As such, the use of the interleaved positively coupled inductors 250 and 252 allows the converter 10 to output the same amount voltage ripple, while using a physically smaller filtering capacitor 260 due to the use of the interleaved coupled inductors 250 and 252. Alternatively, as shown in FIG. 5, the converter 10, indicated by identifier A, is able to output a voltage at output node 56 that has approximately half the amount of voltage ripple, as a converter, indicated by the identifier B, that is structurally equivalent to the converter 10 and utilizes a filtering capacitor of equal capacity to the filtering capacitor 260, but is makes use of interleaved non-coupled inductors in place of the interleaved positively coupled inductors 250 and 252.

It will, therefore, be appreciated that one advantage of one or more embodiments of the present invention is that a bidirectional DC to DC converter converts voltage from one level to another level with reduced ripple. Still another advantage of the present invention is that a bidirectional DC to DC converter converts voltage from one level to another level with reduced ripple, without the need for large, bulky filtering capacitors. Yet another advantage of the present invention is that a bidirectional DC to DC converter utilizes mutually-coupled filter inductors with a positive coupling coefficient to convert voltage from one level to another level with reduced ripple.

Although the present invention has been described in considerable detail with reference to certain embodiments, other embodiments are possible. Therefore, the spirit and scope of the appended claims should not be limited to the description of the embodiments contained herein.

What is claimed is:

1. A bidirectional interleaved DC to DC converter for converting DC power from one voltage level to another voltage level comprising:
a switching network having a first input/output node;
a pair of positively coupled inductors coupled to said switching network to form a second input/output node; and
a controller coupled to said switching network, said controller actuating said switching network, such that power supplied to the first input/output node at one voltage level is converted into another voltage level at said second input/output node, and vice versa, said positively coupled inductors reducing the voltage ripple associated with converted voltage.

2. The bidirectional DC to DC converter according to claim 1, wherein said switching network comprises a plurality of transistors coupled in an interleaved bridge-type configuration.

3. The bidirectional DC to DC converter according to claim 2, further comprising a diode coupled across the collector and emitter terminals of each said transistor.

4. The bidirectional DC to DC converter according to claim 2, wherein said transistors comprise insulated gate bipolar transistors (IGBT).

5. The bidirectional DC to DC converter according to claim 1, further comprising a filtering capacitor coupled to said first input/output node.

6. The bidirectional DC to DC converter according to claim 1, further comprising a filtering capacitor coupled to said second input/output node.

7. The bidirectional DC to DC converter according to claim 1, wherein said controller is coupled to said first input/output to measure the voltage at said first input/output node.

8. The bidirectional DC to DC converter according to claim 7, wherein said controller actuates said switching network to provide a voltage level at said first input/output node in accordance with a duty cycle based on the voltage measured at said first input/output node.

9. The bidirectional DC to DC converter according to claim 7, wherein said controller is coupled to said second input/output node to measure the voltage at said second input/output node.

10. The bidirectional DC to DC converter according to claim 9, wherein said controller actuates said switching network to provide a voltage level at said second input/output node in accordance with a duty cycle based on the voltage measured at said second input/output node.

10. The bidirectional DC to DC converter of claim 1, wherein said switching network comprises:
a first, second, third, and fourth transistor each having a gate terminal, a collector terminal, and an emitter terminal, such that the collector and emitter terminals of said first and second transistors are coupled in series at a first connection node, and said third and fourth transistors that are coupled in series by their emitter and collector terminals at a second connection node, wherein said first and second transistors are coupled in parallel with said third and fourth transistors, such that said collector terminals of said first and second transistors form said first input/output node;
a diode in parallel with the emitter and collector terminals of each said transistor, and said gate terminals of each said transistor coupled to said controller;
wherein one end of each said positively coupled inductor is coupled to said respective first and second connection nodes, and coupled together at another end to form said second input/output node.
